(19) United States
(12) Patent Application Publication
(10) Pub. No.: US 2021/0291196 A1
(43) Pub. Date: Sep. 23, 2021

(54) COAL BENEFICIATION

(71) Applicant: Futura Resources Limited, Sydney (AU)

(72) Inventor: Cameron James VORIAS, Sydney (AU)

(21) Appl. No.: 17/264,488

(22) PCT Filed: Jul. 30, 2019
(86) PCT No.: PCT/AU2019/050797

§ 371 Date: Jan. 29, 2021

(30) Foreign Application Priority Data
Jul. 30, 2018 (AU) 2018902759

(51) Int. Cl. B03B 9/00; B02C 23/14; B03B 5/34; B07B 13/00; C10L 5/04; C10L 9/00; B07B 7/08; B03B 1/00

(52) U.S. Cl. CPC B03B 9/005; B02C 23/14; B03B 5/34; B07B 13/003; C10L 5/04; C10L 2290/54; B07B 7/08; B03B 1/00; B07B 2230/01; C10L 2250/06; C10L 2290/28; C10L 9/00

(57) ABSTRACT

The present invention relates to methods for beneficiating a banded coal of the type wherein a substantial portion of the ash constituents is within the cleats. The method includes subjecting a comminuted coal feed, including coal and ash and having a particle size of about −13.5 mm, to a density separation process to separate the comminuted coal feed, using a separating gravity value of from about 1.35 up to about 1.9, into a beneficiated coal fraction and an ash containing gangue fraction. The method may include the initial steps of subjecting a coarse coal having a size of up to −150 mm to a density separation process to separate the coarse coal into an initial light coal-containing fraction and an initial heavy ash containing gangue fraction; and subjecting at least a portion of the initial light coal-containing fraction to a comminution process to form the comminuted coal feed. The invention extends to a coal product produced by said methods.

### FIELD OF THE INVENTION

The invention relates to a method of coal beneficiation, and a beneficiated coal product produced by such method.

### BACKGROUND OF THE INVENTION

Coal deposits are laid down in marine or estuarine environments under a range of environmental conditions. Over time these deposits are compressed and become interspersed with layers of mud. As a result of these natural processes over millions of years the organic matter converts from peat through brown coal to black coal (typically referred to as just coal). Further geological processes such as volcanic activity or movement of the coal seams can result in the coal being chemically altered or weathered. When coal is exposed to oxygen either via air or water it loses some of the qualities which make it of value as thermal (power station) coal or as coking coal used in steel making.

New processes to produce clean coal have been developed in recent years and continue to be the focus of much research and development in Australia and overseas. These innovations include selective mining techniques and dry sorting which aim to leave the waste material at the mine site, and advances in seismic surveying which allow a better mapping of the coal deposit. However, the mined coal still contains a certain proportion of undesirable ash constituents.

Ash is a term used in the coal industry to represent the waste component of coal. Mined coal does not contain ash but a range of minerals such as clays, silica and others depending on the deposition conditions. Ash refers to the residual weight of a particular coal sample after burning in either a power station or a coke making plant. Ash is a useful term for comparing differing mined coal types. It is specified in a coal sale contract along with the other properties of coal. A typical thermal coal product will contain around 15% to 20% ash. A high-quality coking coal will be around 9% ash to 12% ash.

Given that mined coal contains a proportion of ash constituents, it is usually necessary to clean the coal to reduce the level of these ash constituents. This process is variously referred to as coal preparation, coal beneficiation, or coal washing. The ease which the coal responds to the washing processes is referred to as washability. A coal with good washability will produce a good separation between coal and waste. Low washability coals are difficult to process.

It is still standard practice in mineral beneficiation to extensively crush and grind the ore to liberate finally disseminated minerals. This process consumes significant amounts of energy and it is usual to limit the amount of crushing to the absolute minimum to achieve the desired liberation. Much of the work on the production of clean coal assumes that the coal must be ground very finely in order to remove the ash. However, as size reduction through crushing and grinding is highly energy intensive, the feed should be crushed to no more than the maximum top size required to achieve liberation of the valuable component.

While this approach is economically viable for the beneficiation of coal from high quality coal seams, this approach is not economical for certain coals, such as those where liberation of the coal is difficult e.g. weathered coals. By way of example, the Fort Cooper Coal Measures (FCCM) are part of the extensive coal deposits in the Bowen Basin of Central Queensland. The majority of the Bowen Basin coal deposits are high grade and uniform. However, the FCCM is different in that it has been subjected to considerable weathering via geological activity. During the extensive exploration of the Bowen Basin, it was generally considered that the FCCM could not be economically mined and processed by conventional means.

An object of the invention is to address at least one of the shortcomings of the prior art.

Reference to any prior art in the specification is not an acknowledgement or suggestion that this prior art forms part of the common general knowledge in any jurisdiction or that this prior art could reasonably be expected to be combined with any other piece of prior art by a skilled person in the art.

By way of clarification and for avoidance of doubt, as used herein and except where the context requires otherwise, the term “comprise” and variations of the term, such as “comprising”, “comprises” and “comprised”, are not intended to exclude further additions, components, integers or steps.

### SUMMARY OF THE INVENTION

In a first aspect of the invention, there is provided a method for beneficiating coal, the method including:

subjecting a comminuted coal feed, including coal and ash and having a particle size of about −13.5 mm, to a density separation process to separate the comminuted coal feed, using a separating gravity value of from about 1.35 up to about 1.9, into a beneficiated coal fraction and an ash containing gangue fraction.

The particle size of −13.5 mm is intended to mean that the comminuted coal feed has a particle size that is −13.5 mm, e.g. the coal feed is sized to pass a standard 13.5 mm (0.530 in.) mesh. Preferably, the particle size less than about −12.7 mm e.g. the coal feed is sized to pass a standard 12.7 mm (½ in.) mesh. More preferably, the particle size is −11.2 mm e.g. the coal feed is sized to pass a standard 11.2 mm ( 7/16 in.) mesh. Still more preferably the particle size is −9.51 mm e.g. the coal feed is sized to pass a standard 9.51 mm (⅜ in.) mesh. Even more preferably, the particle size is −8.0 mm e.g. the coal feed is sized to pass a standard 8.0 mm ( 5/16 in.) mesh. Most preferably, the particle size is −6.35 mm e.g. the coal feed is sized to pass a standard 6.35 mm (¼ in.) mesh.

In an embodiment, the coal feed has a particle top size of about 13.5 mm. This top size corresponds to a standard 0.530 in. mesh, which has a nominal sieve opening of 13.5 mm and therefore allows the passage of particles having a top size of up to 13.5 mm. Preferably, the top size is about 12.7 mm. This top size corresponds to a standard ½ in. mesh which has a nominal sieve opening of 12.7 mm and therefore allows the passage of particles having a top size of up to 12.7 mm. More preferably, the top size is about 11.2 mm. This top size corresponds to a standard 7/16 in. mesh which has a nominal sieve opening of 11.2 mm and therefore allows the passage of particles having a top size of up to 11.2 mm. Still more preferably, the top size is about 9.51 mm. The top size of 9.51 mm corresponds to a standard ⅜ in. mesh which has a nominal sieve opening of 9.51 mm and therefore allows the passage of particles having a top size of up to 9.51 mm. Even more preferably, the top size is about 8.0 mm. This top size corresponds to a standard 5/16 in. mesh which has a nominal sieve opening of 8.0 mm and therefore allows the passage of particles having a top size of up to 8.0 mm. Most preferably, the top size is about 6.35 mm. This top size corresponds to a standard ¼ in. mesh which has a nominal sieve opening of 6.35 mm and therefore allows the passage of particles having a top size of up to 6.35 mm.

There is no particular bottom size of the comminuted coal feed. However, in an embodiment, the bottom size is +0.15 mm. Preferably, the bottom size is +0.5 mm.

In an embodiment, at least a portion of the comminuted coal has a particle size that is greater than 2.44 mm.

In an embodiment, at least a portion of the comminuted coal has a particle size that is greater than 3.36 mm.

In an embodiment, at least a portion of the comminuted coal has a particle size that is greater than 4.00 mm.

In an embodiment, the separating gravity value is from about 1.4. Preferably, the separating gravity value is from about 1.5. More preferably, the separating gravity value is from about 1.6. Most preferably, the separating gravity value is from about 1.65. Alternatively, or additionally, the separating gravity value is up to about 1.85. More preferably, the separating gravity value is up to about 1.8. Most preferably, the separating gravity value is up to about 1.75. In one form of the invention, the separating gravity value is about 1.7.

In an embodiment, the density separation process is a dense medium cyclone separation process.

In an embodiment, the comminuted coal feed has an ash content of 18 wt % or more, such as 20 wt % or greater, or 22 wt % or greater, or 25 wt % or greater. Alternatively, or additionally, the comminuted coal feed has an ash content of up to 40 wt %. Preferably, the comminuted coal feed has an ash content of up to 30 wt %.

In an embodiment, the beneficiated coal has an ash content of 12.5 wt % or less. Preferably, the beneficiated coal has an ash content of 12.0 wt % or less.

In an embodiment, prior to the step of subjecting the comminuted coal feed to the density separation process, the method further includes desliming the coal.

The method may include the initial step of subjecting the coal to the comminution process to form the comminuted coal feed.

In an embodiment, prior to the step of subjecting the comminuted coal feed to the separation process, the method initially includes:

subjecting a coarse coal having a size of up to −150 mm to a density separation process to separate the coarse coal, using a separating gravity value of from about 1.35 up to about 1.9, into an initial light coal-containing fraction and an initial heavy ash containing gangue fraction; and subjecting at least a portion of the initial light coal-containing fraction to a comminution process to form the comminuted coal feed.

In an embodiment, the step of subjecting at least a portion of the initial light coal-containing fraction to a comminution process to form the comminuted coal feed further includes classifying the coal into a fraction of the comminuted coal feed.

In one form of the above embodiment, the coarse coal separation process is a dense medium separation process.

In an embodiment, the coarse coal and the comminuted coal (as appropriate) are banded coals, for example, a highly banded coal.

In an embodiment, the coarse coal and the comminuted coal (as appropriate) include tuffaceous ash constituents.

In an embodiment, the coarse coal and the comminuted coal (as appropriate) have cleats, wherein ash constituents are within the cleats. Preferably, a substantial proportion of the ash constituents are within the cleats. By substantial it is meant greater than 50 wt % of the ash constituents is found in the cleats of the coal. Preferably, 60 wt % of the ash constituents is found in the cleats of the coal.

In an embodiment, the ash constituents include tuffaceous material.

In an embodiment, the comminuted coal feed includes tuffaceous material and the gangue stream includes a substantial portion of the tuffaceous material.

In an embodiment, the coarse coal and comminuted coal (as appropriate) is a Bowen Basin coal from seams in the Fair Hill Formation and Fort Cooper Coal Measures.

In an embodiment, the method is a method for beneficiating coal to form a coking coal, and the beneficiated coal is a coking coal.

In a second aspect of the invention, there is provided a method for beneficiating coal, the method including:

subjecting a coarse coal, including a mixture of coal and ash and having a size of up to −150 mm, to a density separation process to separate the coarse coal, using a separating gravity value of from about 1.35 up to about 1.9, into a coal-containing fraction and an ash containing gangue fraction; and

subjecting at least a portion of the coal-containing fraction to a comminution process to form a comminuted coal feed;

classifying the comminuted coal feed into at least a first fraction and a second fines fraction, the first fraction having a top particle size of −13.5 and a bottom particle size, and the second fines fraction having a top particle size that is less than the bottom particle size of the first fraction;

subjecting the first fraction to a density separation process to separate the comminuted coal feed, using a separating gravity value of from about 1.35 up to about 1.9, into a beneficiated coal fraction and an ash containing gangue fraction.

In an embodiment, the method further includes:

subjecting the second fraction to a density separation process to separate the comminuted coal feed, using a separating gravity value of from about 1.35 up to about 1.9, into a beneficiated coal fraction and an ash containing gangue fraction.

In an embodiment, the bottom particle size is +0.5 mm. In another embodiment, the bottom particle size is +0.15 mm.

Furthermore, the embodiments discussed in relation the first aspect of the invention also apply to the second aspect of the invention as applicable.

In a third aspect of the invention there is provided a coal product produced according to the method described above. Preferably, the coal product is a coking coal.

In a further aspect of the invention, there is provided a method for beneficiating a banded coal of the type having cleats wherein a substantial portion of the ash constituents is within the cleats, the method including:

subjecting a comminuted coal feed, including coal and ash and having a particle size of about −13.5 mm, to a density separation process to separate the comminuted coal feed, using a separating gravity value of from about 1.35 up to about 1.9, into a beneficiated coal fraction and an ash containing gangue fraction.

In an embodiment, prior to the step of subjecting the comminuted coal feed to the separation process, the method initially includes:

subjecting a coarse coal having a size of up to −150 mm to a density separation process to separate the coarse coal, using a separating gravity value of from about 1.35 up to about 1.9, into an initial light coal-containing fraction and an initial heavy ash containing gangue fraction, wherein the coarse coal contains a substantial portion of the ash constituents in the cleats; and

subjecting at least a portion of the initial light coal-containing fraction to a comminution process to form the comminuted coal feed.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: Process flow diagram illustrating a process according to an embodiment of the invention.

FIG. 2: Graph showing Rosin Rammler ‘OLD-A’ sample with comparison to wet and dry tumbled ALS core hole 213.

FIG. 3: Graph showing Rosin Rammler ‘QLD-A’ sample after crushing Float 1.70 Fractions.

FIG. 4: Graph showing theoretical washability results for +0.15 mm material

FIG. 5: Graph showing release analysis data for raw and liberated material from ‘QLD-A’

FIG. 6: Graph showing product yield vs. ash comparison for coking and middlings Products.

### DETAILED DESCRIPTION OF THE EMBODIMENTS

The inventor has surprisingly found that certain coals, traditionally considered to be unrecoverable from a commercial perspective, can be treated with a comminution process to remove ash constituents from the coal and to provide a high grade beneficiated coal product (such as coke) at commercial yields.

The method of the invention is particularly applicable to coal obtained from formations in which a substantial portion of the ash constituents is present in the cleats of the coal rather than within the coal body or coal structure itself. By way of background, some coal deposits have been subject to various weathering conditions which have resulted in the accumulation of ash constituents within the cleats of that coal. Such weathering conditions may include local volcanic activity which generates a tuffaceous material that can contaminate coal seams. Traditionally, the high level of ash constituents in these coals has rendered the extraction and beneficiation of these coals as uneconomical.

The inventors have developed a method for removal of the ash constituents, which can provide an economical solution to the beneficiation of these coals, e.g. by adopting the method of the invention the removal of the ash constituents becomes more effective, which can lead to an economical yield of an upgraded coal product. Ideally, the coal product is coking coal as this has a higher commercial value than thermal coal.

The process broadly includes subjecting a comminuted coal feed having a coal particle size of from about −13.5 mm (and most preferably −6.35 mm) to a density separation process to separate the comminuted coal feed, based on a separation gravity value, into a light coal-containing fraction and a heavy gangue fraction. The inventor has found that a separation gravity in the range of 1.35 to 1.9, and particularly around 1.7, allows for an effective separation of the ash constituents into the heavy gangue fraction. Consequently, the light coal-containing fraction has a relatively low proportion of ash constituents, such as 12.5 wt % or less.

This process differs from standard coal process, in which coal may be crushed to a size of −2.0 mm (e.g. having a top size of 2 mm, and sized to pass a standard No. 10 mesh). Crushing the coal to a larger top size than in a typical process for producing coking coal e.g. in which at least a proportion of the coal is of a size that is greater than 2 mm, to achieve effective removal of the ash constituents is counter-intuitive. The prevailing view of those skilled in the art is that to produce an upgraded coal from a raw coal that has a high content of ash constituents or ash constituents that are difficult to remove, the coal should be ground to a smaller particle size to better liberate the ash constituents from the coal. This is one of the key reasons that coal deposits, such as the Fort Cooper Coal Measures (FCCM) in the Bowen Basin are generally regarded by those skilled in the art as being uneconomical e.g. the capital and operating energy costs to grind FCCM coal to a sufficiently small size and then to subsequently separate the ash constituents from the coal is too costly.

The inventor has also undertaken extensive research to ascertain the reason that treating this coarser ground coal leads to a higher yield of a high quality coal product than in comparison with a more finely ground coal as per the standard approach.

The inventor has found that heavily banded coals (such as FCCM coals) include a substantial proportion of the ash constituents within the cleats of the coal as opposed to within the coal body or coal structure itself. This phenomenon is particularly pronounced in coals, such as FCCM coals, that have been exposed to volcanic activity. In the case of the FCCM coals, there is significant accumulation of tuffaceous material within the cleats of the coal. While there has been little research into methods for upgrading coal where a substantial portion of the ash constituents are retained within the cleats of the coal, the inventor has found that by subjecting a coarser coal grind e.g. to a size of −13.5 mm (and preferably to −6.35 mm), to the method of the invention, the ash constituents can be more effectively liberated from the cleats of the coal. Furthermore, the larger particle size of the coal and ash constituents means that separation of these ash-generating materials from the coal via a density separation process (e.g. processes that separate products according to density, including but not limited to, gravity separation, centrifugal separation, flotation etc.) becomes more effective.

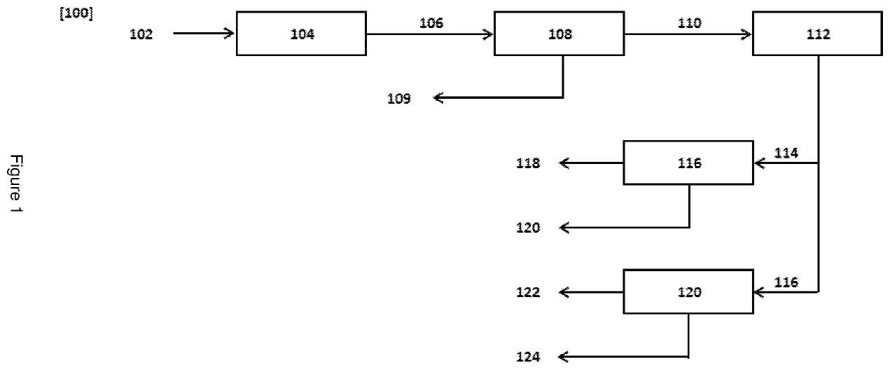

FIG. 1 is a process flow diagram illustrating a process 100 according to an embodiment of the invention.

A raw coal feed 102 of QLD-A coal is initially subjected to a comminution process 104 to provide a coarse coal feed 106 having a particle size of −150 mm e.g. the coarse coal feed 106 has a top size of 150 mm. In this case a 150 mm coarse coal feed top size was selected to reduce excessive generation of fines e.g. to minimise the proportion of the coarse coal feed having a particle size of −0.5 mm. Initially, a 50 mm coarse coal feed top size was considered, but this would require an additional step of crushing high ash raw coal prior to the process, resulting in increased operating costs with no likely yield benefit.

The coarse coal feed is 106 is fed to a primary density separation process 108, such as using a dense medium vessel (DMV), to separate ash constituents from the coal and provide a waste ash-containing stream 109 and a coarse coal feed with reduced ash content 110. Due to the anticipated high feed ash content of FCCM coals (with coarse rock), deshaling the 150×6 mm fraction in the DMV was incorporated into the design. Utilisation of a DMV prior to crushing allows coarse rock to be removed, thus significantly reducing the amount of material that must be crushed to −6.35 mm.

The coarse coal feed 106 with reduced ash content 110 is then subjected to a comminution process 112 where it is crushed to pass a 6.35 mm mesh and classified into two product streams: (i) a comminuted coal 114 having a size in the range of −6.35 mm to +0.5 mm and (ii) a fine comminuted coal 116 having a size of −0.5 mm. This classification step is optional.

The comminuted coal 114 is fed to a density separation process 116 to remove ash constituents from the comminuted coal and provide an upgraded coal 118 and a waste ash-containing gangue stream 120. In this particular embodiment, dense medium cyclones (DMC) are used with a separating gravity of 1.7. DMC are useful in separation processes where low separating gravities are required with extremely large percentages of near gravity material. 1 mm is a typical bottom size in large diameter DMC's reducing screening requirements. However, the inventors have found that processing to a bottom size of 0.5 mm in the DMC circuit can enhance coal yield (+2-3% points). The upgraded coal 118 may then be subjected to further processing, such as in a secondary DMC. It is this treatment of the comminuted coal 114 that forms the subject matter of one aspect of the present invention, e.g. subjecting a comminuted coal feed to a density separation process to separate the comminuted coal feed and provide a beneficiated coal product. In this particular embodiment, the comminuted coal is sized to pass a 6.35 mm mesh. However, larger sizes can be used, for example having a top size to pass a 13.5 mm mesh.

The fine comminuted coal 116 is fed to a density separation process 120 to remove ash constituents from the fine comminuted coal and provide an upgraded coal 122 and a waste ash-containing gangue stream 124. In this embodiment, the fine comminuted coal was fed into a reflux classifier. Reflux classifiers are particularly useful when low separating gravities (<1.80) are required on the fine coal size fractions.

The skilled person will appreciate that variations may be made to the above process. By way of example, in an alternative embodiment, the process does not include a classification step after comminution of the coarse coal feed 106. In this alternative embodiment, all of the comminuted coal 114 (having a size of −6.35 mm) is fed to density separation process 116, e.g. there is no separate treatment of the fines.

### EXAMPLE

This example reports work relating to the treatment of coal from the Fairhill coal formation located in the Bowen Basin region of Queensland, Australia; with an aim to produce a high quality coking coal product and a secondary thermal product. The results herein include washability and release analysis as well as a custom liberation crushing protocol to assess potential yield/quality advantages.

Detailed laboratory liberation test work was conducted on a large bulk sample from the Fairhill Formation. Work performed in this study illustrates that crushing the Float 1.70 coarse fraction liberated significant quantities of low density material (e.g. conducting flotation separation using a separation gravity of 1.7).

Washability Protocol

The laboratory work and testing protocol into four main tasks:
1. Feed Preparation and Characterisation
2. Crushed Middlings Preparation and Characterisation
3. Flotation Analysis and Characterisation

A sample of coal from the Fairhill coal formation, referred to as ‘OLD −A’, was received and labelled and placed in cold storage to avoid oxidation until ready for analysis. The sample was extremely coarse in an effort to ensure that the samples contained a representative quantity of out of seam dilution that could be present in the coal preparation plant feed. The feed stock was subjected to drop shatter testing and screened at 50 mm. The plus 50 mm material was handpicked to pass 50 mm as this most accurately approximates the effects of a raw coal sizer. In addition, dry and wet tumble testing was performed on the sample to simulate degradation. This prepared the feed samples for characterisation.

The degraded feed sample was screened into 50×12.7, 12.7×6.35, 6.35×2.44, 2.44×1, 1×0.15, and 0.15 mm×0 size fractions. Float sink work was performed on each of the plus 0.15 mm size classes at 1.30, 1.35, 1.40, 1.45, 1.50, 1.60, 1.70, 1.80, and 2.0 relative densities. The 0.15 mm×0 was subjected to flotation release analysis.

In Task 2, the Float 1.70 material from the 50×12.7 fraction was crushed to pass 12.7 mm and screened into the 6.35×2.44, 2.44×1, 1×0.15 mm, and 0.15 mm size fractions. The Float 1.70 material from the 12.7×6.35 mm fraction was crushed to pass 6.35 mm and screened at the same size fractions. Also, the raw 6.35×2.44 and 2.44×1 mm fractions were crushed to pass 1 mm and sized accordingly. The crushed material from each of the three selected liberation sizes was subjected to further washability and flotation release analyses using the same relative density classes used in Task 1.

Sizing Data

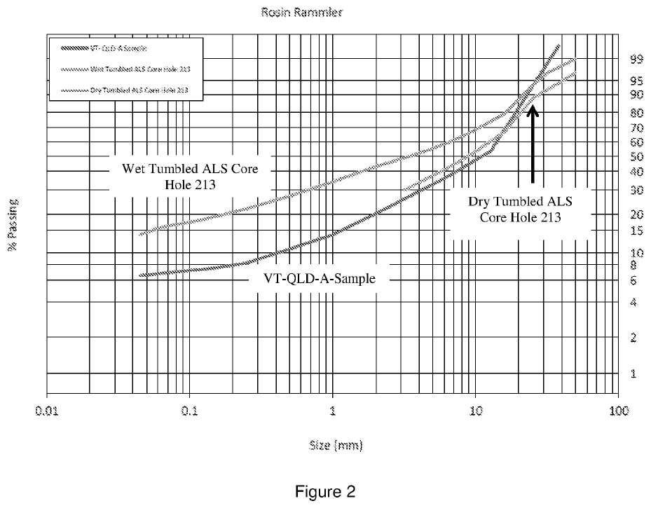

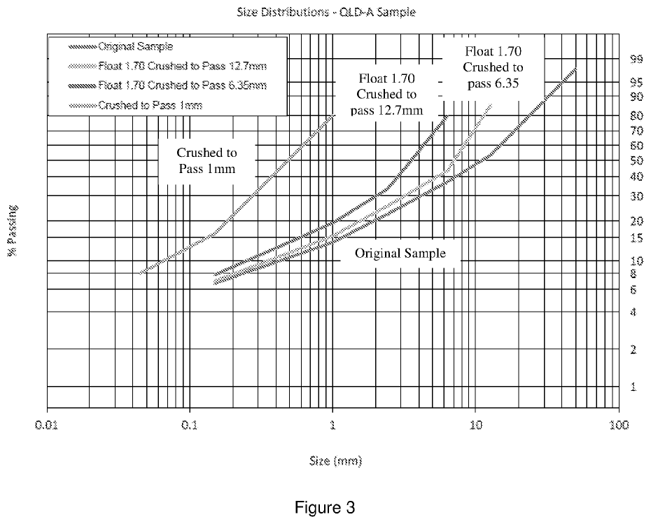

The ‘QLD-A’ sample was drop shattered and wet tumbled to pass 50 mm for an accurate approximation of the plant feed size distribution. However, as mentioned above, the sample was coarser than expected to include out of seam dilution in the samples to avoid over estimating the plant yield. Although the sample is coarser than expected, it is expected to provide a realistic head ash if mining conditions require mining rock plys between the coal layers. The sizing envelope can be found in FIG. 2 and FIG. 3.

Washability Data

The liberation potential of the coarse Float 1.70 material was evaluated for the 50×12.7 mm and 12.7×6.35 mm fractions. Full characterisation was performed on the Float 1.70 from both size fractions after crushing to 12.7 and 6.35 mm, respectively. Similarly, the raw 6.35×1 mm material was crushed to pass 1 mm.

The OLD-A coal showed excellent liberation potential. A significant amount of low ash material was liberated when the coarse Float 1.70 material was crushed. In the case of the 50×12.7 mm liberation scenario, the ash content of the low SG crushed material was slightly higher than the original washability (of the same size fraction). This slightly higher ash content in the low SG fractions was offset by the high weight percentage of low ash material present in these fractions. As a result, liberation to 12.7 mm resulted in a significant increase in Float 1.30 SG material and a slight reduction in ash content on this density fraction. A similar result was observed with the 6.35 mm liberation case, but the impact was not as significant the 12.7 mm liberation scenario. This was expected because the raw 12.7×6.35 mm was naturally more liberated than the raw 50×12.7 mm.

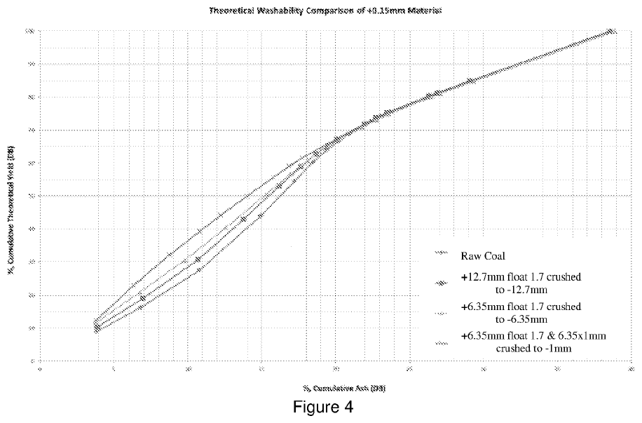

FIG. 4 illustrates the theoretical washability data for the +0.15 mm material. The composited liberated feed washabilities contained the sink 1.70 material in the coarser fractions; this ensured that each composite is directly comparable with respect to cumulative yield and ash. From this plot, the crushed Float 1.70 material in the +12.7 and +6.35 mm fractions theoretically increased the yield on the plus 0.15 mm material by 4 and 7 percentage points, respectively.

As an additional check, plots for the raw Float 1.70 washability from the 50×12.7 and 50×6.35 mm size classes were plotted along with the post crushing washability (for these size classes). The 50×12.7 mm and 50×6.35 mm Float 1.70 material represented approximately 32% and 42% of the total plant feed. These plots showed the theoretical yield difference between each liberation option. This summary was not performed for the raw 6.35×1 mm material crushed below 1 mm because a significant portion of the sample reported to 0.15 mm×0, which was not part of the Float sink evaluation.

All washability data was expanded into 16 gravity fractions prior to simulations. Tables 1 through 5 detail the expanded washability for the raw washability and each liberation case.

TABLE 1
Original QLD-A Washability
ORIGINAL WASHABILITY

| | | 50 × 12. | | 12.7 × 6.35 | | 7 6.35 × 2.44 | | 2.44 × 1 | | 1 × 0.15 | | 0.15 × 0 | |
|---|---|---|---|---|---|---|---|---|---|---|---|---|---|
| | | Wt % = 46.754 | | Wt % = 16.241 | | Wt % = 14.559 | | Wt % = 8.605 | | Wt % = 7.132 | | Wt % = 6.71 | |
| Specific Gravity | | Wt | Ash | Wt | Ash | Wt | Ash | Wt | Ash | Wt | Ash | Wt | Ash |
| 1.2 | 1.3 | 0.32 | 4.5 | 6.07 | 4.97 | 19.66 | 3.81 | 31.5 | 3.49 | 23.83 | 3.66 | 10.96 | 12.24 |
| 1.3 | 1.35 | 2.43 | 10.73 | 9.64 | 10.56 | 14.1 | 11.41 | 12.35 | 10.84 | 14.73 | 8.11 | 10.25 | 16.77 |
| 1.35 | 1.4 | 12.09 | 16.49 | 14.23 | 17.17 | 8.83 | 17.41 | 6.48 | 16.41 | 8.51 | 13.22 | 6.71 | 24.09 |
| 1.4 | 1.45 | 23.57 | 22.05 | 11.57 | 22.33 | 9.64 | 21.68 | 6.6 | 21.26 | 6.87 | 17.51 | 5.26 | 33.57 |
| 1.45 | 1.5 | 15.23 | 26.94 | 7.51 | 26.45 | 6.48 | 28 | 2.07 | 24.75 | 4.79 | 21.56 | 66.82 | 87.51 |
| 1.5 | 1.55 | 6.84 | 30.47 | 5.82 | 31.3 | 4.17 | 30.65 | 3.85 | 27.42 | 3.88 | 28.03 | | |
| 1.55 | 1.6 | 3.67 | 34.69 | 4.52 | 35.83 | 3.09 | 33.8 | 3.92 | 31.09 | 3.35 | 31.7 | | |
| 1.6 | 1.65 | 2.94 | 40.69 | 2.7 | 40.58 | 2.31 | 37.72 | 2.58 | 35.28 | 2.39 | 36.23 | | |
| 1.65 | 1.7 | 2.1 | 45.08 | 1.87 | 44.31 | 1.94 | 41.41 | 2.16 | 39.4 | 1.98 | 39.46 | | |
| 1.7 | 1.8 | 3.77 | 50.03 | 3.65 | 49.39 | 4.23 | 47.57 | 4.45 | 46.51 | 3.64 | 44.45 | | |
| 1.8 | 1.9 | 1.13 | 49.56 | 1.28 | 55.89 | 2.27 | 53.87 | 2.28 | 53.14 | 2.38 | 51.48 | | |
| 1.9 | 2 | 1.08 | 54.44 | 1.42 | 60.93 | 1.98 | 60.82 | 1.88 | 60.4 | 2.45 | 57.63 | | |
| 2 | 2.17 | 4.8 | 66.18 | 5.81 | 69.14 | 4.72 | 71.44 | 4.46 | 71.21 | 4.7 | 73.22 | | |
| 2.17 | 2.2 | 1.01 | 72.3 | 1.21 | 75.02 | 0.89 | 77.74 | 0.83 | 77.59 | 0.89 | 78.58 | | |
| 2.2 | 2.3 | 3.6 | 76.81 | 4.3 | 79.49 | 3.06 | 81.81 | 2.86 | 81.65 | 3.11 | 81.73 | | |
| 2.3 | 2.4 | 15.42 | 90.66 | 18.4 | 95.47 | 12.62 | 94.24 | 11.73 | 93.8 | 12.5 | 90.89 | | |
| | | 100 | 40.75 | 100 | 42.99 | 99.99 | 34.7 | 100 | 31.03 | 100 | 31.53 | 100 | 64.92 |

TABLE 2
QLD-A-50 × 12.7 mm Float 1.70 Crushed Below 12.7 mm
50 × 12.7 CRUSHED BELOW 12.7

| | | 50 × 12. | | 12.7 × 6.35 | | 7 6.35 × 2.44 | | 2.44 × 1 | | 1 × 0.15 | | 0.15 × 0 | |
|---|---|---|---|---|---|---|---|---|---|---|---|---|---|
| | | Wt % = 46.754 | | Wt % = 16.241 | | Wt % = 14.559 | | Wt % = 8.605 | | Wt % = 7.132 | | Wt % = 6.71 | |
| Specific Gravity | | Wt | Ash | Wt | Ash | Wt | Ash | Wt | Ash | Wt | Ash | Wt | Ash |
| 1.2 | 1.3 | | | 1.18 | 5.95 | 8.47 | 4.87 | 23.96 | 3.86 | 33.11 | 3.06 | 34.08 | 11.44 |
| 1.3 | 1.35 | | | 5.09 | 10.86 | 16.15 | 11.64 | 17.27 | 10.98 | 14.53 | 9.5 | 31.94 | 18.88 |
| 1.35 | 1.4 | | | 19.9 | 17.04 | 19.65 | 17.02 | 12.53 | 16.44 | 8.78 | 14.91 | 15.6 | 25.76 |
| 1.4 | 1.45 | | | 24.48 | 21.47 | 13.86 | 21.99 | 9.47 | 21.02 | 8.11 | 19.36 | 8.52 | 39.89 |
| 1.45 | 1.5 | | | 23.47 | 26.61 | 14.54 | 26.72 | 9.47 | 25.68 | 5.07 | 22.9 | 9.86 | 79.31 |
| 1.5 | 1.55 | | | 10.76 | 31.59 | 8.03 | 31.35 | 6.51 | 29.53 | 5.45 | 26.55 | | |
| 1.55 | 1.6 | | | 5.68 | 35.52 | 5.16 | 35.24 | 4.91 | 33.35 | 5.02 | 30.28 | | |
| 1.6 | 1.65 | | | 4.06 | 39.63 | 3.63 | 39.27 | 3.55 | 37.75 | 3.76 | 34.12 | | |
| 1.65 | 1.7 | | | 2.28 | 43.42 | 2.43 | 43.2 | 2.58 | 41.51 | 3 | 37.83 | | |
| 1.7 | 1.8 | | | 2.13 | 48.22 | 3.63 | 49 | 3.62 | 46.53 | 4.39 | 43.27 | | |
| 1.8 | 1.9 | | | 0.56 | 53.12 | 1.79 | 54.39 | 2.23 | 52.8 | 2.84 | 50.36 | | |
| 1.9 | 2 | | | 0.12 | 57.05 | 0.9 | 60.26 | 1.39 | 59.63 | 1.89 | 58.42 | | |
| 2 | 2.17 | | | 0.15 | 61.13 | 0.89 | 68.4 | 1.26 | 69.54 | 1.85 | 70.16 | | |
| 2.17 | 2.2 | | | 0.02 | 63.29 | 0.1 | 72.07 | 0.14 | 73.92 | 0.21 | 75.6 | | |
| 2.2 | 2.3 | | | 0.04 | 63.46 | 0.24 | 72.51 | 0.34 | 74.51 | 0.54 | 76.64 | | |
| 2.3 | 2.4 | | | 0.08 | 63.01 | 0.52 | 72.17 | 0.78 | 74.33 | 1.44 | 77.18 | | |
| | | | | 100 | 25.11 | 99.99 | 23.91 | 100.01 | 20.78 | 99.99 | 19.24 | 100 | 25.17 |

TABLE 3
QLD-A-50 × 12.7 mm Float 1.70 Crushed Below 6.35 mm
50 × 12.7 CRUSHED BELOW 6.35

| | | 50 × 12. | | 12.7 × 6.35 | | 7 6.35 × 2.44 | | 2.44 × 1 | | 1 × 0.15 | | 0.15 × 0 | |
|---|---|---|---|---|---|---|---|---|---|---|---|---|---|
| | | Wt % = 46.754 | | Wt % = 16.241 | | Wt % = 14.559 | | Wt % = 8.605 | | Wt % = 7.132 | | Wt % = 6.71 | |
| Specific Gravity | | Wt | Ash | Wt | Ash | Wt | Ash | Wt | Ash | Wt | Ash | Wt | Ash |
| 1.2 | 1.3 | | | | | 3.9 | 5.8 | 13.87 | 3.63 | 24.92 | 3.1 | 31.13 | 12.19 |
| 1.3 | 1.35 | | | | | 6.11 | 11.7 | 15.9 | 10.42 | 14.48 | 8.75 | 22.28 | 17.19 |
| 1.35 | 1.4 | | | | | 17.3 | 16.94 | 13.58 | 15.81 | 11.11 | 14.09 | 26.16 | 18.52 |
| 1.4 | 1.45 | | | | | 17.01 | 21.61 | 13.01 | 20.7 | 8.75 | 18.43 | 12.95 | 32.62 |
| 1.45 | 1.5 | | | | | 23.05 | 26.56 | 11.56 | 25.17 | 8.08 | 22.74 | 7.47 | 73.51 |
| 1.5 | 1.55 | | | | | 12.19 | 31.42 | 9.1 | 29.34 | 6.59 | 26.75 | | |
| 1.55 | 1.6 | | | | | 7.32 | 35.5 | 7.08 | 33.36 | 5.53 | 30.43 | | |
| 1.6 | 1.65 | | | | | 4.55 | 40.03 | 4.25 | 37.16 | 4.31 | 33.96 | | |
| 1.65 | 1.7 | | | | | 2.52 | 43.52 | 2.69 | 40.75 | 3.43 | 37.64 | | |
| 1.7 | 1.8 | | | | | 3.24 | 47.73 | 3.76 | 46.1 | 5.05 | 43.34 | | |
| 1.8 | 1.9 | | | | | 1.44 | 53.56 | 2.24 | 52.45 | 2.76 | 50.6 | | |
| 1.9 | 2 | | | | | 0.55 | 59.02 | 1.23 | 58.95 | 1.62 | 58.39 | | |
| 2 | 2.17 | | | | | 0.43 | 65.81 | 0.9 | 67.85 | 1.65 | 69.51 | | |
| 2.17 | 2.2 | | | | | 0.05 | 68.93 | 0.1 | 71.73 | 0.18 | 74.62 | | |
| 2.2 | 2.3 | | | | | 0.12 | 69.16 | 0.25 | 72.14 | 0.45 | 75.4 | | |
| 2.3 | 2.4 | | | | | 0.21 | 68.56 | 0.47 | 71.66 | 1.09 | 75.46 | | |
| | | | | | | 99.99 | 26.21 | 99.99 | 22.45 | 100 | 20.23 | 99.99 | 22.19 |

TABLE 4
QLD-A-12.7 × 6.35 mm Crushed Below 6.35 mm
12.7 × 6.35 CRUSHED BELOW 6.35

| | | 50 × 12. | | 12.7 × 6.35 | | 7 6.35 × 2.44 | | 2.44 × 1 | | 1 × 0.15 | | 0.15 × 0 | |
|---|---|---|---|---|---|---|---|---|---|---|---|---|---|
| | | Wt % = 46.754 | | Wt % = 16.241 | | Wt % = 14.559 | | Wt % = 8.605 | | Wt % = 7.132 | | Wt % = 6.71 | |
| Specific Gravity | | Wt | Ash | Wt | Ash | Wt | Ash | Wt | Ash | Wt | Ash | Wt | Ash |
| 1.2 | 1.3 | | | | | 7.55 | 3.85 | 23.39 | 3.63 | 31.02 | 3.22 | 18.73 | 9.52 |
| 1.3 | 1.35 | | | | | 16.88 | 10.8 | 19.3 | 10.08 | 14.08 | 8.44 | 18.23 | 14.4 |
| 1.35 | 1.4 | | | | | 11.85 | 16.52 | 14.01 | 15.6 | 13.35 | 13.64 | 14.15 | 17.8 |
| 1.4 | 1.45 | | | | | 20.36 | 21.08 | 12.52 | 20.45 | 8.17 | 18.74 | 27.01 | 19.23 |
| 1.45 | 1.5 | | | | | 16.71 | 26.65 | 8.81 | 24.94 | 6.47 | 22.41 | 21.88 | 63.35 |
| 1.5 | 1.55 | | | | | 9.63 | 30.96 | 6.56 | 29.27 | 5.92 | 26.24 | | |
| 1.55 | 1.6 | | | | | 6.33 | 34.51 | 4.98 | 33.28 | 5.13 | 30.16 | | |
| 1.6 | 1.65 | | | | | 4.33 | 38 | 3 | 37.49 | 3.75 | 34.51 | | |
| 1.65 | 1.7 | | | | | 2.7 | 41.36 | 1.91 | 40.94 | 2.79 | 38.5 | | |
| 1.7 | 1.8 | | | | | 2.9 | 46.05 | 2.76 | 45.47 | 3.36 | 43.93 | | |
| 1.8 | 1.9 | | | | | 0.52 | 53.29 | 1.24 | 52.33 | 1.93 | 50.17 | | |
| 1.9 | 2 | | | | | 0.09 | 58.42 | 0.53 | 59.41 | 1.2 | 58.76 | | |
| 2 | 2.17 | | | | | 0.08 | 63.5 | 0.51 | 68.76 | 1.25 | 71.86 | | |
| 2.17 | 2.2 | | | | | 0.01 | 66.25 | 0.06 | 73.04 | 0.15 | 77.84 | | |
| 2.2 | 2.3 | | | | | 0.02 | 66.42 | 0.14 | 73.44 | 0.38 | 78.97 | | |
| 2.3 | 2.4 | | | | | 0.04 | 65.77 | 0.28 | 72.73 | 1.05 | 79.22 | | |
| | | | | | | 100 | 22.51 | 100 | 18.14 | 100 | 17.76 | 100 | 25.98 |

TABLE 5
QLD-A-6.35 ×1 mm Crushed Below 1 mm
6.35 ×1 mnn CRUSHED BELOW 1 mm

| | | 50 × 12. | | 12.7 × 6.35 | | 7 6.35 × 2.44 | | 2.44 × 1 | | 1 × 0.15 | | 0.15 × 0 | |
|---|---|---|---|---|---|---|---|---|---|---|---|---|---|
| | | Wt % = 46.754 | | Wt % = 16.241 | | Wt % = 14.559 | | Wt % = 8.605 | | Wt % = 7.132 | | Wt % = 6.71 | |
| Specific Gravity | | Wt | Ash | Wt | Ash | Wt | Ash | Wt | Ash | Wt | Ash | Wt | Ash |
| 1.2 | 1.3 | | | | | | | | | 16.27 | 3.78 | 20.60 | 11.83 |
| 1.3 | 1.35 | | | | | | | | | 14.08 | 9.27 | 13.08 | 16.73 |
| 1.35 | 1.4 | | | | | | | | | 12.00 | 14.86 | 10.05 | 21.55 |
| 1.4 | 1.45 | | | | | | | | | 9.46 | 20.05 | 9.95 | 27.81 |
| 1.45 | 1.5 | | | | | | | | | 6.43 | 23.68 | 46.33 | 85.94 |
| 1.5 | 1.55 | | | | | | | | | 7.82 | 27.49 | | |
| 1.55 | 1.6 | | | | | | | | | 7.17 | 31.44 | | |
| 1.6 | 1.65 | | | | | | | | | 4.64 | 34.62 | | |
| 1.65 | 1.7 | | | | | | | | | 3.48 | 37.86 | | |
| 1.7 | 1.8 | 12.24 | 50.03 | 10.12 | 49.39 | | | | | 5.34 | 42.96 | | |
| 1.8 | 1.9 | 3.67 | 49.56 | 3.55 | 55.89 | | | | | 3.33 | 49.4 | | |
| 1.9 | 2 | 3.51 | 54.44 | 3.94 | 60.93 | | | | | 2.13 | 57.05 | | |
| 2 | 2.17 | 15.58 | 66.18 | 16.11 | 69.14 | | | | | 2.38 | 69.40 | | |
| 2.17 | 2.2 | 3.28 | 72.30 | 3.35 | 75.02 | | | | | 0.37 | 75.31 | | |
| 2.2 | 2.3 | 11.68 | 76.81 | 11.92 | 79.49 | | | | | 1.13 | 78.20 | | |
| 2.3 | 2.4 | 50.05 | 90.66 | 51.01 | 95.47 | | | | | 3.99 | 85.98 | | |
| | | 100.00 | 76.88 | 100.00 | 81.21 | | | | | 100.00 | 25.84 | 100.00 | 49.37 |

Flotation Data

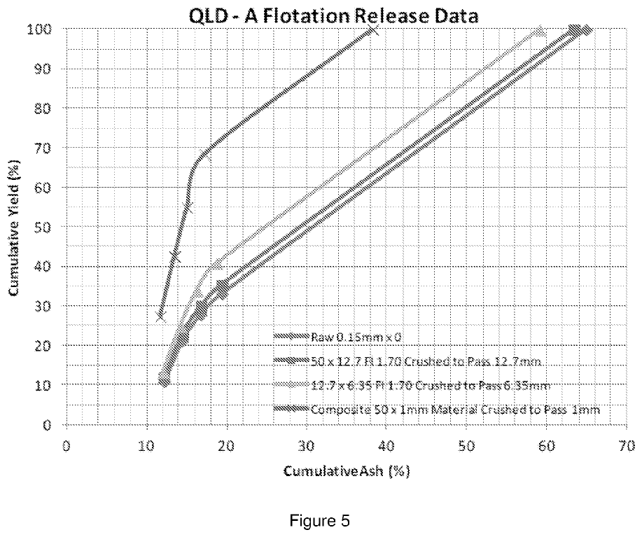

Flotation release tests were performed on raw coal and liberated material from each sample. Results are shown in Table 6 and FIG. 5. In this simulation work, the flotation performance yield was assumed to be 95% of the cumulative concentrate four (C4) mass yield at equivalent cumulative ash content to account for plant inefficiency.

TABLE 6
QLD-A-Flotation Release Analysis
QLD - A Flotation Release Analysis Summary

| | Raw 0.15 mm × 0 | | | |
|---|---|---|---|---|
| Product | Wt % | Ash % | Cum. Wt % | Cum. Ash % |
| C1 | 10.96 | 12.24 | 10.96 | 12.24 |
| C2 | 10.25 | 16.77 | 21.21 | 14.43 |
| C3 | 6.71 | 24.09 | 27.92 | 16.75 |
| C4 | 5.26 | 33.57 | 33.18 | 19.42 |
| Tailings | 66.82 | 87.51 | 100 | 64.92 |
| | 50 × 12.7 Fl 1.70 Crushed to Pass 12.7 mm | | | |
| Product | Wt % | Ash % | Cum. Wt % | Cum. Ash % |
| Cl | 11.83 | 12.15 | 11.83 | 12.15 |
| C2 | 11.07 | 17 | 22.9 | 14.5 |
| C3 | 7.05 | 24.23 | 29.95 | 16.79 |
| C4 | 5.38 | 33.95 | 35.33 | 19.4 |
| Tailings | 64.67 | 87.46 | 100 | 63.42 |
| | 12.7 × 6.35 Fl 1.70 Crushed to Pass 6.35 mm | | | |
| Product | Wt % | Ash % | Cum. Wt % | Cum. Ash % |
| Cl | 13.24 | 12.07 | 13.24 | 12.07 |
| C2 | 11.75 | 16.7 | 24.99 | 14.24 |
| C3 | 8.91 | 22.09 | 33.9 | 16.31 |
| C4 | 6.91 | 31.08 | 40.81 | 18.81 |
| Tailings | 59.19 | 86.97 | 100 | 59.15 |
| | Composite + 1 mm Material Crushed to Pass 1 mm | | | |
| Product | Wt % | Ash % | Cum. Wt % | Cum. Ash % |
| Cl | 27.48 | 11.72 | 27.48 | 11.72 |
| C2 | 15.1 | 16.71 | 42.59 | 13.49 |
| C3 | 12.43 | 20.58 | 55.02 | 15.09 |
| C4 | 13.29 | 26.19 | 68.32 | 17.25 |
| Tailings | 31.68 | 83.57 | 100 | 38.26 |

The laboratory work illustrated that the liberated 0.15 mm×0 fractions were more selective than the raw 0.15 mm×0 material.

Process Simulation

Process simulations were run on the QLD-A samples with a view to maximise coking coal yield and assess the ability to produce a marketable middlings product specifications are as follows:
12-12.5% (db)—Coking Product
2.5%—Inherent Moisture
5%—Plant Feed Surface Moisture
4.5%—% Hydrogen
5000 kcal/kg (net ar)—Middlings Product
7600 kcal/kg—DAF Calorific Value

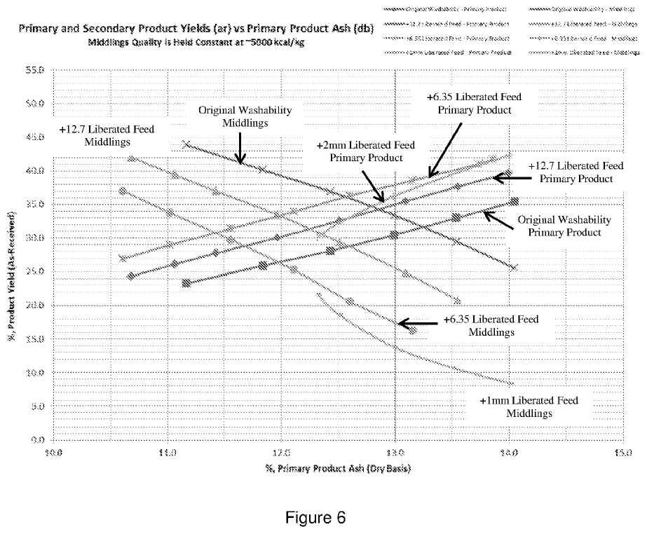

Simulation results are detailed in FIG. 6 for the raw coal feed and for each liberation scenario (12.7, 6.35, and 1 mm). The following approach was adopted, as outlined in Table 7 below:

TABLE 7
Coal preparation plant unit processes

| Size Fraction | | | Unit Process |
|---|---|---|---|
| 50 | × | 6.35 | Primary DMV (High SG)-crush product to pass 6.35 mm |
| 6.35 | × | 0.5 | Primary DMC (High SG)-Natural and crushed 6.35 × 0.5 mm |
| 6.35 | × | 0.5 | Secondary DMC (Low SG) |
| 0.5 | × | 0.15 | Reflux Classifier (Low SG) |
| 0.5 | × | 0.15 | Spiral Concentrator (High SG) |
| 0.15 | × | 0 | Single Stage Column Flotation |

Optimised plant simulations were run over a range of coking product ash contents (11-14%); the coking product dry ash specification was defined as 12-12.5%. In each simulation, separating gravities were controlled and optimised to maximise the coking coal yield for a given target ash. The optimisation was based on targeting equal incremental ash contents in each gravity concentration device. The primary DMC circuit gravity was controlled to meet the 5000 kcal/kg specification, while the secondary spirals achieved a constant 1.80 SG separation.

In general, the coking coal DMC circuit separating gravities range between 1.37 and 1.42 over the 11-14% ash product range for the QLD-A sample. Ultimately, a 1.40 separating gravity was required in the DMC to achieve the 12-12.5% coking coal specification. The reflux classifier circuit separating gravity, responsible for producing the 0.5×0.15 mm coking product, ranged from 1.46 to 1.52 over the 11-14% ash plant coking product range. A 1.50 separating gravity in this unit, along with a 1.40 separating gravity in the DMC will result in an optimised separation.

Because of the high percentage of near gravity material present around the target separating gravities, the flowsheet emphasises accurate density control down to 0.15 mm. Further to this, relatively low SG separations are required on the QLD-A coal to meet the product specifications. The simulations revealed several key flowsheet design features that maximised coking coal yield.
Crushing to pass 6.35 mm promoted liberation of low ash material
The requirement for low SG separations down to 0.15 mm eliminated spirals from the coking circuit design
Minimised the amount of material reporting to flotation due to poor floatability.
Maximised the quantity of material processed in the DMC circuit maximising efficiency

It will be understood that the invention disclosed and defined in this specification extends to all alternative combinations of two or more of the individual features mentioned or evident from the text or drawings. All of these different combinations constitute various alternative aspects of the invention.

1. A method for beneficiating coal having cleats of the type wherein a substantial portion of ash constituents of the coal is within the cleats, the method including:
subjecting a comminuted coal feed, including coal and ash and having a particle size of about −13.5 mm, to a density separation process to separate the comminuted coal feed, using a separating gravity value of from about 1.35 up to about 1.9, into a beneficiated coal fraction and an ash containing gangue fraction.

2. The method of claim 1, wherein the particle size is of about −12.7 mm.

3. The method of claim 2, wherein the particle size is of about −6.35 mm.

4. The method of claim 1, wherein the particle size is from about +0.15 mm.

5. The method of claim 1, wherein the separating gravity value is from about 1.6 to about 1.8.

6. The method of claim 1, wherein the comminuted coal feed has an ash content of from 18 wt % up to 40 wt %.

7. The method of claim 1, wherein the beneficiated coal has an ash content of 12.5 wt % or less.

8. The method of claim 1, wherein prior to the step of subjecting the comminuted coal feed to the density separation process, the method includes desliming the coal.

9. The method of claim 1, wherein the density separation process is a dense medium cyclone separation process.

10. The method of claim 1, wherein prior to the step of subjecting the comminuted coal feed to the separation process, the method initially includes:
subjecting a coarse coal having a size of up to −150 mm to a density separation process to separate the coarse coal, using a separating gravity value of from about 1.35 up to about 1.9, into an initial light coal-containing fraction and an initial heavy ash containing gangue fraction; and
subjecting at least a portion of the initial light coal-containing fraction to a comminution process to form the comminuted coal feed.

11. The method of claim 10, wherein the coarse coal separation process is a dense medium separation vessel process.

12. The method of claim 1, wherein the coal is a banded coal.

13. The method of claim 1, wherein the ash constituents include tuffaceous ash constituents.

14. The method of claim 1, wherein the comminuted coal is a comminuted Bowen Basin coal from seams in the Fair Hill Formation and Fort Cooper Coal Measures.

15. The method of claim 1, wherein the method is a method for beneficiating coal to form a coking coal, and the beneficiated coal is a coking coal.

16. A method for beneficiating coal, the method including:
subjecting a coarse coal having a size of up to −150 mm, to a density separation process to separate the coarse coal, using a separating gravity value of from about 1.35 up to about 1.9, into a coal-containing fraction and an ash containing gangue fraction, wherein the coal-containing fraction has cleats of the type where a substantial portion of ash constituents of the coal-containing fraction is within the cleats; and
subjecting at least a portion of the coal-containing fraction to a comminution process to form a comminuted coal feed;
classifying the comminuted coal feed into at least a first fraction and a second fines fraction, the first fraction having a top particle size of −13.5 and a bottom particle size, and the second fines fraction having a top particle size that is less than the bottom particle size of the first fraction;
subjecting the first fraction to a density separation process to separate the comminuted coal feed, using a separating gravity value of from about 1.35 up to about 1.9, into a beneficiated coal fraction and an ash containing gangue fraction.

17. The method of claim 16, further including:
subjecting the second fines fraction to a density separation process to separate the comminuted coal feed, using a separating gravity value of from about 1.35 up to about 1.9, into a beneficiated coal fraction and an ash containing gangue fraction.

18. The method of claim 16, wherein the bottom particle size is +0.5 mm.

19. A method of claim 1 which includes the step of subjecting the coal to the comminution process to form the comminuted coal feed.

20. A coal product produced according to the method of claim 1.
